(19) United States
(12) Patent Application Publication
(10) Pub. No.: US 2012/0185363 A1
(43) Pub. Date: Jul. 19, 2012

(54) Pick Up and Drop Off Package Delivery System

(76) Inventor: Daniel Ayers Gilbert, Arden, NC (US)

(21) Appl. No.: 13/346,758

(22) Filed: Jan. 10, 2012

Related U.S. Application Data
(60) Provisional application No. 61/461,114, filed on Jan. 13, 2011.

(51) Int. Cl. G06Q 50/28; G06Q 30/06

(52) U.S. Cl. 705/27.1

(57) ABSTRACT

A package pick up and delivery system allows distribution of packages between any two locations serviced by a carrier or delivery system. At each location, merchandise, different from the packages handled by this system, would be available to the public. Such locations can include big box stores, drug stores, restaurants and similar retail or commercial establishments. A website is available to the shipper to identify pick up and delivery locations and to record payment for the shipment. Information for notifying the recipient can be input to the website and a notice sent to the recipient, who can subsequently access the website to determine the status of the shipment. This system allows the operator of a freight distribution or carrier system to increase the utilization of the carrier system. Patronage of retail establishments, operating as pick up and drop off locations can also be increased.

### CROSS REFERENCE TO PRIOR CO-PENDING APPLICATIONS

This application claims the benefit of prior co-pending applications, U.S. Provisional Patent Application 61/461,114 filed Jan. 13, 2011 and U.S. Provisional Patent Application 61/520,344 filed Jun. 8, 2011.

### BACKGROUND OF THE INVENTION

For most Americans who want to send and/or receive a package economically there are few choices. The major US package shipping entities are the quasi-governmental United States Postal Service, as well as commercial package delivery services that deliver packages to and from business to business; to and from business to consumer; and to and from consumer to consumer. The three largest of these package delivery services provide package pickup and delivery to every business and residential address in the country. To provide this level of service requires tremendous investment in personnel and capital investment in rolling equipment like trucks and trailers. Along with ongoing cost of equipment and personnel to make these home deliveries and pickups there is the ever increasing cost of vehicle fuel. Besides the high cost of these home pickups and deliveries there is a problem with security. All three entities leave the package at the door or at the street mail box and by the same token the customer can leave a package that they want to ship in the same insecure place. Packages left at exposed locations are tempting to anyone walking or driving by. Only upon special request will the package be held at the terminal of the carrier or the local post office for pickup by the customer.

### SUMMARY OF THE INVENTION

A package pick up and delivery system according to this invention can be employed by the general public, including consumers and small businesses. This system, includes a website accessible by a potential shipper, whether business or individual. This website includes a menu identifying a package shipping location and a package pick up location so that a user can select both a package shipping location and a package pick up location. The shipping location is accessible by the shipper, but is not the shipper's address since this system does not comprise a conventional door to door package delivery system. The package pick up location, which is accessible to a recipient, but is not the recipient's address is also identified. The website also includes a payment system for calculating shipping charges and recording payment by the shipper. The website also provides the means for communicating with the recipient to identify the package pick up location and an estimated delivery date. The website is accessible by the recipient to determine current package delivery status. The package shipping location and the package pick up locations each comprise retail establishments dealing in merchandise unrelated to the package being shipped and of the type which both the shipper and the recipient can patronize.

According to another aspect of this invention system for pick up and delivery of packages is intended for use in conjunction with a freight distribution system for delivering merchandise to commercial establishments in multiple locations. This will allow the operator of the freight distribution system to increase utilization of its resources in a manner that is compatible with its normal business without adversely affecting the conventional operation of the freight distribution system or increasing its cost. This system includes a publicly accessible website including a menu allowing a user to designate both a drop off location and a pick up location from among the multiple locations to which the merchandise is delivered by the freight distribution system. This website includes means for determining a shipping cost for a package delivered by the user to a designated drop off location for delivery to a designated pick up location, and the website can be used to record payment of the shipping cost by the user. The system includes a package tracking subsystem allowing packages to be picked up from any of the multiple locations for delivery for any other one of the multiple locations.

### DESCRIPTION OF THE PREFERRED EMBODIMENT

The innovative concept described in this disclosure will be the basis for a business, having a freight distribution system, to compete directly with existing package delivery services, such as United Parcel Service (UPS), FedEx Ground (Fed Ex) and the United States Postal Service (USPS). Instead of providing home delivery and pickup to and from millions of individual addresses, approximately 4000 pickup and drop off (PUDO) stations would be located in the United States alone. These PUDO stations would be located at or near a store of a major chain of big box stores. The PUDO stations could be located inside the box store, in the parking lot or anywhere close by. One example of big box chain stores has about 4000 retail or member stores across the country and about 100,000,000 customers visit one location of this one chain every week. All big box chains have done customer research that shows where the stores need to be located to attract enough customers to make it viable. Those same customers are the ones that will be using the PUDO stations. The pickup and dropoff by the customers can occur on the customer's normal trip to the big box store. One major advantage of implementing this system with a big box chain, is that they already have most of the rolling stock (trucks and trailers) to handle the transportation of packages to and from the PUDO station and a distribution center. It should be understood that this invention is not limited to a single retail chain, and one illustrative example has merely been referred to as an example. This system is not limited to use by big box retail chains. Other retail chains could also implement this system. For example, drug store, convenience store, or restaurant chains could also implement this system. This delivery system can be implemented either in a single country or in multiple countries or even internationally. One advantage of such a system would be that it could first be implemented in a single country, such as the United States, and it could then be expanded to other countries, without altering the basic system and the procedures employed to implement the system as initially deployed.

When the packages are dropped off at the PUDO station they are received by a person who scans them into the system using a package tracking system. The customer knows that his package is secure until it is handed over to the receiver at the other end of the trip.

For added security and to advise the shipper and customer of the progress of the package at every leg of the journey the location of the package and its status will be texted, emailed or phoned to both the shipper and the receiver. The recipient can also request a status update at any time. Since the receiver knows the progress of the package they can plan their trip to an outlet of the national chain to pick up his or her package. Since the package will be delivered to the pick up location only, the package cannot be left unattended at the recipient's home of place of business. This provides additional security and will eliminate opportunities for theft and reduce the possibility that the package will be lost. By insuring delivery to a dedicated delivery facility, situations in which a business must replace a package, which may have been lost by either the shipper or the recipient will be significantly diminished.

As part of this concept there will be a website that allows the shipper to go on line to print out a shipping label. A menu will be provided to allow the shipper to select, for example, which of the 4000 PUDO's they are shipping from and which of the 4000 PUDO's they are shipping to. The customer will enter the weight of the package in ranges 1 to 5 pounds, 6 to 10 pounds, etc and then the package dimensions. The website would calculate a cost and the customer would pay for the shipping with a credit card. Once paid for, the customer would be able to print out a shipping label and then take the package to their nearby PUDO station to drop it off. Each PUDO station can have a drop through window if that is compatible with that specific location or the drop off can occur at one or more designated counters in the facility.

At the present time there are two ways to track a package being shipped by the three major US package delivery services or any other shipping company. One is to go online and enter the package or shipment number. The shipper's automated system will respond with an Internet page showing the shipping status of the package. The other method of tracking is to call into a call center of the shipping company and the shipper's representative can tell the customer the status of his or her shipment.

The instant invention can make use of a tracking system that can be publicly interrogated by either the shipper or recipient or it can employ another additional or alternate method of tracking shipments. Simple and short text messages from the customer or consumer's mobile phone to the shipping companies can function in the shippers logistic system according to at least one aspect of this invention to allow a response from the shipper to the consumer as a text message or part of an SMS message to the consumer identifying the current status of the shipment. Periodic texts from the shipper, independent of any query from the customer, can update the status of the shipment and its expected arrival date. Unexpected delays or text message inquiries from the recipient can also be sent to the shipping customer.

An additional feature of this system is a mobile application that can be employed in conjunction with global positioning or (GPS) capability on a mobile phone or other mobile communications device. This mobile application can alert the recipient of the receipt of a shipped package when he or she is within a prescribed distance from the physical shipping destination if the package is ready for pick up. In this way the recipient will have the opportunity to pick up his package and save time and the cost of a separate trip. Of course this capability can be separate from or in addition to notification by facsimile, text, phone, e-mail or any other communications service or network.

Although this PUDO will benefit from identification with a particular nationwide chain of retail establishments, it is not necessary that the retail chain be nationwide. For example, many grocery stores or supermarket chains do not operate nationwide. However, virtually every municipality is served by at least one or more regional chain grocery stores or supermarkets. Similarly other commercial establishments, such as restaurants, may not provide nationwide coverage, but virtually every community is served by one or more restaurant franchises that are part of a larger chain. Since the shipper will have the capability of employing an Internet or other communications network to prepare the package to be shipped, it will only be necessary for the shipper to identify the shipping and delivery location, for example by Zip Code, and suitable pickup and delivery locations can be identified by a web based server with which the shipper is communicating. The web based software can then allow the shipper to choose shipping and delivery locations from a menu, or can specify locations, which may provide the most inexpensive shipping and delivery locations. If the cost of shipping between alternate shipping and delivery locations is different, the web based software can specify the cost for each combination of pickup and delivery locations. The shipper may not wish to choose the least expensive quoted option, if other considerations, such as the distance to the respective locations for either the shipper or recipient is large, or if other considerations, such as local traffic congestion would be a significant issue to the shipper or to the recipient.

One significant advantage to retail establishments to operate pick up and delivery locations will be the increase in customer traffic. A customer using pick up and delivery locations will have the opportunity to patronize that retailer, and can combine either a drop off or a pick up by purchasing the retailer's other products or by purchasing a meal, if the participating location is a restaurant or has restaurant facilities.

Another significant advantage to a retail chain is that virtually every retail chain either operates its own carrier fleet or uses a contract carrier, or is serviced by a carrier. An example of the latter situation would be the restaurant supply services that regularly deliver to all restaurants. Utilization of these carrier fleets to ship packages should result in a more complete utilization of this resource. Furthermore, the shipping carriers typically operate from larger supply hubs or regional locations or warehouses, with trucks delivering to individual retailer establishments, and the incremental cost of additional package shipping will be small, since it will not be necessary to add significant facilities or equipment.

Established package shipping companies can also take advantage of this pickup and delivery service. The established shipping companies can operate pick and delivery locations at the retail locations. These package shipping companies can use their own fleet or can use the carrier fleets currently servicing the retail establishments for either primary or backup fleet capability.

An individual or small business can easily employ this system as part of a two step process. First the website or web based server or communications system, allows this small shipper to prepare his package, including a shipping label, and pay for the service, after which the individual shipper then delivers the package to an appropriate drop off location. The recipient will then be notified of the shipping location via the Internet or by an SMS service or by another communications service.

I claim:

1. A package pick up and delivery system comprising:
a website accessible by a potential shipper, the website including a menu identifying a package shipping location and a package pick up location so that a user can select both a package shipping location and a package pick up location, whereby the shipping location is accessible by the shipper, but is not the shipper's address, and the package pick up location, which is accessible to a recipient, but is not the recipient's address;
the website also including a payment system for calculating shipping charges and recording payment by the shipper;
the website also communicating with the recipient to identify the package pick up location and an estimated delivery date, as well as means accessible by the recipient to determine current package delivery status;
wherein the package shipping location and the package pick up locations each comprise retail establishments dealing in merchandise unrelated to the package being shipped and of the type which both the shipper and the recipient can patronize.

2. The package pick up and delivery system of claim 1 including a carrier delivering merchandise unrelated to the package being shipped as well as the package being shipped.

3. The package pick up and deliver system of claim 1 wherein the shipping and pick up locations comprise store locations of a chain retailer.

4. The package pick up and delivery system of claim 3 wherein the shipping and pick up locations comprise store locations of the same chain retailer.

5. The package pick up and delivery system of claim 1 wherein the shipping and pick up locations comprise drug stores.

6. The package pick up and delivery system of claim 1 wherein the shipping and pick up locations comprise restaurants.

7. The package pick up and delivery system of claim 1 wherein multiple package shipping locations and a package pick up locations are identified, and the shipper can select one of the package shipping locations and one of the package pick up locations.

8. The package pick up and delivery system of claim 1 wherein the website offers the choice, by the recipient, of communication with the recipient via text, e-mail, telephone to provide incremental transit progress.

9. A system for pick up and delivery of packages, comprising:
a freight distribution system for delivering merchandise to commercial establishments in multiple locations;
a publically accessible website including a menu allowing a user to designate both a drop off location and a pick up location from among the multiple locations to which the merchandise is delivered by the freight distribution system, wherein the website includes means for determining a shipping cost for a package delivered by the user to a designated drop off location to a designated pick up location, and means for recording payment of the shipping cost by the user, and
a package tracking subsystem allowing packages to be picked up from any of the multiple locations for delivery to any other one of the multiple locations.

10. The system for pick up and delivery of packages of claim 9 wherein the multiple locations each comprise a retail location.

11. The system for pick up and delivery of packages of claim 10 wherein the retail locations sell merchandise unrelated to the packages to be picked up and delivered by the system.

12. The system for pick up and delivery of packages of claim 18 wherein the freight distribution system comprises a hub and spoke system in which merchandise is primarily delivered from at least one hub to multiple spokes.

13. The system for pick up and delivery of packages of claim 12 wherein the freight distribution system comprises multiple hubs.

14. The system for pick up and delivery of packages of claim 12 wherein the hub comprises a warehouse for storing merchandise unrelated to the packages to be delivered.

15. The system for pick up and delivery of packages of claim 9 wherein the multiple locations comprise retail locations for multiple retail chains.

16. The system for pick up and delivery of packages of claim 9 wherein each package is traceable using a compatible GPS system.

17. The system for pick up and delivery of packages of claim 9 wherein a text message alert is sent from the delivery location to the recipient upon arrival of the package at the delivery location.

18. The system for pick up and delivery of packages of claim 8 including a mobile communications application in which a recipient employing a GPS enabled mobile communications device can specify a distance so that the recipient will be notified when within the selected distance of a pick up location at which recipient's package has been received.

19. A package pick up and delivery system comprising:
a website on a server, the website being accessible by a potential shipper, the website including a menu identifying a package shipping location and a package pick up location so that a user can select both a package shipping location and a package pick up location, whereby the shipping location is accessible by the shipper, but is not the shipper's address, and the package pick up location, which is accessible to a recipient, but is not the recipient's address;
the website also including a payment system for calculating shipping charges and recording payment by the shipper;
the website also communicating with the recipient to identify the package pick up location and an estimated delivery date, as well as means accessible by the recipient to determine current package delivery status;
wherein the package shipping location and the package pick up locations each comprise commercial establishments dealing in merchandise unrelated to the package being shipped and of the type which both the shipper and the recipient can patronize and,
wherein the system includes a confirmation device at the pick up location communicable with the server to provide positive confirmation of receipt of the package by the commercial establishment before any notification to the recipient of delivery to the pick up location so that unattended delivery of the package is not possible.

20. The package pick up and delivery system of claim 19 wherein at least a portion of the transfer of the package takes place using a freight delivery system affiliated with the commercial establishment.
